(19) United States
(12) Patent Application Publication
(10) Pub. No.: US 2025/0024434 A1
(43) Pub. Date: Jan. 16, 2025

(54) DELAY ENCODED VECTOR SYMBOLIC RADIO MULTIPLE ACCESS

(71) Applicant: Telefonaktiebolaget LM Ericsson (publ), Stockholm (SE)

(72) Inventors: András VERES, Budapest (HU); András RÁCZ, Budapest (HU); Péter HÁGA, Budapest (HU); Zsolt KENESI, Budapest (HU); Tamas BORSOS, Budapest (HU)

(21) Appl. No.: 18/711,418

(22) PCT Filed: Nov. 10, 2022
(86) PCT No.: PCT/SE2022/051050

§ 371 Date: May 17, 2024

Related U.S. Application Data
(60) Provisional application No. 63/280,175, filed on Nov. 17, 2021.

(51) Int. Cl. H04W 72/044

(52) U.S. Cl. CPC H04W 72/044

(57) ABSTRACT

A method by a neuromorphic device in a wireless communication network which communicates using radio frames and carrier frequencies. The method includes obtaining a high dimensional (HD) vector containing symbols. At least some symbols have a value indicating a pattern of firing events for associated one or more neurons of a neural network (NN). For each symbol in the HD vector having a nonzero value, selecting a subframe of a radio frame and/or a carrier frequency among a set of carrier frequencies, based on a defined mapping between subframes of the radio frame and/or carrier frequencies of the set and the locations of symbols in the HD vector, determining a time offset relative to the selected subframe and/or a frequency offset relative to the selected carrier frequency.

### TECHNICAL FIELD

The present disclosure relates to communicating vectors from high-dimensional neuromorphic computing through radio interfaces.

### BACKGROUND

One important trend that is expected to increase with availability of 6G wireless communications is Artificial Intelligence (AI) applications, sensors and agents that communicate information sent between neurons or between layers of Neural Networks (NN). Some particularly demanding and novel application types include neuromorphic systems where NN outputs need to be communicated. These neuromorphic systems are often considered as 3rd generation of AI. Neuromorphic systems include NNs and Spiking Neural Networks (SNN), as well as, more generic neuromorphic compute, which does not necessarily include AI and learning capability.

Neuromorphic systems can mimic the operation of biological neurons. SNN use spike-based communication in which information represented by spikes is transported between the neurons. A spike itself can be considered as binary data, where the presence of a spike implicitly carries the information. An example of neuromorphic devices which generate spike type of data includes event cameras, where each pixel directly feeds corresponding neuron(s) and these neurons emit spikes when the change in light intensity exceeds a predefined threshold. Other types of neuromorphic sensors, such as artificial cochlea, skin or touch sensors directly generate output spike signals. Other neuromorphic devices include actuators, such as robotic arms, which can be controlled by input spike signals. Semiconductor chips can be configured to perform neuromorphic computing, in contrast to traditional arithmetic logic computations, and which are more suitable to process the spike signal outputs of neuromorphic sensors.

The basic operation of an example neuron circuit model is illustrated in FIG. 1. Each spike received on any of the input synapses of the neuron circuit increases the voltage potential of the neuron circuit and when it reaches a threshold value, the neuron circuit emits an output spike. A spike received on any one of the input synapses of the neuron circuit is typically weighted by a weight value which is associated with that synapse, also referred to as a synapse weight. The neuron circuit is referred to as having a “firing event” when it operates to an output spike. The term “neuron circuit” is also referred to herein as “neuron” for brevity. The model is also referred to as an integrate and fire neuron model. A SNN is typically a collection of many hundreds, thousands, or millions of such neurons, which are inter-connected via synapses. The connections may be full mesh but are typically not full mesh by providing connections among localized neurons and typically only a very small fraction of all neurons is active at the same time.

The need for communicating traffic between AI agents is predicted to become a significant portion of radio communication in the future. The “language” between AI agents is very different from conventional conversational or Internet traffic both from their traffic pattern and requirements point of views. One area of interest is how AI agents should encode different types of values for radio communications, and how those encodings can be suitable to transfer neural activities representing e.g., real valued representation of physical sensors, or neural activities between neural groups across a radio channel.

Advances in neuroscience have shown new insights into how higher layer concepts or symbols are represented by the biological brain, as well as how the brain can manipulate these symbols for reasoning about them. In recent years the mathematical foundations of this theory has been established, under several names. Hyperdimensional Computing investigates the means of how simple symbols (e.g., numbers, words, physical objects, etc.) can be mapped onto a High-Dimensional (HD) space. The theory of Vector Symbolic Architectures (VSA) takes these HD spaces and defines a few operations e.g., permutation, binding and bundling, to enable the manipulation of symbols in HD vectors.

Sensor technology is one important area where neuromorphic technology is emerging. One particular example is neuromorphic cameras, also called event cameras (as mentioned above), where each pixel is associated with one or more neurons that emit spikes when the light intensity detected at pixel is changing. For example, there can be two neurons per pixel, where one neuron is spiking in response to light intensity increase, while the other spikes to light intensity decrease. When nothing is happening in the scene, no events are generated. These cameras often have a large dynamic range and a large temporal resolution (on the microsecond scale). Note that the processing of such camera events requires completely different image processing solutions, as the camera outputs per pixel individual events and image reconstruction does not even take place.

The processing of such spiking camera events naturally gives the option to do it in neuromorphic compute way. Thereby it can be beneficial to avoid the transcoding of such events into conventional number format and doing regular arithmetic operations on it in order to take advantage of the low delay and energy efficiency of spike based processing. It is noted that a conventional image processing has to process all the continuously incoming images and all the pixels on the image all the time, irrespectively of whether anything has happened in particular pixels. In the neuromorphic processing, compute happens only when changes happen in the scene and only those pixels need to be processed where changes occurred. It is also noted that the communication volume of a neuromorphic camera is typically much lower than that of a shutter based camera due to the idle pixels not being communicated and still the temporal resolution can be ×1000 times better.

Another scenario where communication between NNs will be needed is when an SNN or a neuromorphic system, in general is distributed at multiple locations and which need to act together as one SNN or spiking system. The reasons for distribution may be manyfold and are similar to reasons of distributing a conventional NN. One example is when the data is distributed with different type of data pieces located at different places and some central logic wants to make a global decision. Instead of transmitting the raw data to the central place and running a large NN there, one can run the lower layers of the NN at the place where the data is located and transfer only the output of these lower NN layers, which is expected to be reduced in size as compared to the raw data.

Another reason for the split could be to share the computation, when for example, on the local device there is only limited neuron compute capacity and the higher level tasks are performed elsewhere. It could also be that at different stages of the processing different types of neurons are needed. This is similar to the human brain where e.g., at the low level, instinct driven tasks are performed in different parts of the brain with different neuron structures and types as compared to higher level cognitive tasks.

Another example where spike communication would be needed is when larger systems are built e.g., from spiking sensor and compute elements. An example could be in a factory environment with human robot collaboration where neuromorphic cameras, neuromorphic skins on the person and sensors on the robot provide input to the processing and control logic or may be even neural sensors in the human body or brain activity sensors provide neural input to the control logic. Based on all this information the controller may command the robotic arm such that it cooperates with the human, avoids hazardous human-machine collisions, etc. The timely sensing and processing is particularly important in such a robot-human collaboration and this alone motivates the use of high temporal resolution neuromorphic sensors and corresponding neuromorphic compute and communication.

FIG. 2 illustrates an example factory use-case where a set of neuromorphic devices (e.g., cameras, vision analysis algorithm, sensors, robotic arm, and control algorithm) use NNs for their operation. All devices produce neural output, and may also need neural input. All the arrows in the figure represent neural information to be exchanged over wireless radio resources.

In current technology, all devices would need to exit the neuromorphic domain and use regular digital communication technologies to communicate with their peers. For example, a neural activity pattern representing temperature would need to be translated to a 32 bit float number (e.g., 20.5 Celsius), and then sent as an IP packet. On the receiving end, the float number would need to be re-encoded as neural activities. This is suboptimal as it complicates the devices, introduces delays and may eliminate benefits of neuromorphic computing e.g., low power operation.

### SUMMARY OF THE INVENTION

Some embodiments disclosed herein are directed to a method by a neuromorphic device in a wireless communication network which communicates using radio frames and carrier frequencies. The method includes obtaining a high dimensional (HD) vector containing symbols, wherein at least some of the symbols have a value operative to indicate a pattern of firing events for associated one or more neurons of a neural network (NN). The method further includes, for each symbol in the HD vector having a nonzero value, selecting a subframe of a radio frame and/or a carrier frequency among a set of carrier frequencies, based on a defined mapping between subframes of the radio frame and/or carrier frequencies of the set and the locations of symbols in the HD vector, determining a time offset relative to the selected subframe and/or a frequency offset relative to the selected carrier frequency, based on the value of the symbol, and transmitting an impulse at the determined time offset relative to the selected subframe and/or at the determined frequency offset relative to the selected carrier frequency.

Some other embodiments are directed to a method by a device in a wireless communication network which communicates using radio frames and carrier frequencies. The method further includes, for an impulse that was received, identifying a time offset in a subframe of a radio frame when the impulse was received and/or a frequency offset of the impulse relative to a carrier frequency. The method further includes determining a value of a symbol based on the identified time offset and/or frequency offset, wherein the value of the symbol operates to indicate a pattern of firing events for associated one or more neurons of a NN, and storing the value of the symbol at a location in a HD vector determined based on a defined mapping between: locations of symbols in the HD vector; and subframes of the radio frame and/or carrier frequencies of a set.

Some other embodiments are directed to a corresponding neuromorphic device in a wireless communication network which communicates using radio frames and carrier frequencies. The neuromorphic device is adapted to obtain a HD vector containing symbols, where at least some of the symbols have a value operative to indicate a pattern of firing events for associated one or more neurons of a NN. The neuromorphic device is adapted to, for each symbol in the HD vector having a nonzero value, select a subframe of a radio frame and/or a carrier frequency among a set of carrier frequencies, based on a defined mapping between subframes of the radio frame and/or carrier frequencies of the set and the locations of symbols in the HD vector, determine a time offset relative to the selected subframe and/or a frequency offset relative to the selected carrier frequency, based on the value of the symbol, and transmit an impulse at the determined time offset relative to the selected subframe and/or a radio symbol at the determined frequency offset relative to the selected carrier frequency. In one embodiment, the neuromorphic device is adapted to transmit no impulse and no radio symbol for any symbol in the HD vector having a zero value.

Some other embodiments are directed to a corresponding device in a wireless communication network which communicates using radio frames and carrier frequencies. The device is adapted to, for an impulse that was received, identify a time offset in a subframe of a radio frame when the impulse was received and/or a frequency offset of the impulse relative to a carrier frequency. The device is further adapted to determine a value of a symbol based on the identified time offset and/or frequency offset, wherein the value of the symbol operates to indicate a pattern of firing events for associated one or more neurons of a NN, and to store the value of the symbol at a location in a HD vector determined based on a defined mapping between: locations of symbols in the HD vector; and subframes of the radio frame and/or carrier frequencies of a set.

Some potential advantages of these embodiments are that they can enable a neuromorphic device to communicate with other neuromorphic devices more seamlessly without exiting the neuromorphic computation domain. Various embodiments may provide robustness against noise and interference, which can enable a radio circuit to be configured to implement only very simple algorithms, e.g., simplified modulation, no or simplified channel equalization, no retransmissions, etc. The receiver (RX) and transmitter (TX) operations can be fully neuromorphic compatible, so they can be performed in native neuromorphic computing (NC) domain. If the receiver knows the acceptable symbol(s) (e.g., its address, or even a complex bundled structure), the receiver only needs to listen on those specific subframes. On the transmitter side, the transmitter may only need to transmit very sparsely. Even when the vectors are large, the vectors can be very sparse, and only bits of “1” need to be transmitted. This is because the information is carried by the pattern of a very few “1”s across a large vector space.

Other methods, neuromorphic devices, and related devices according to embodiments will be or become apparent to one with skill in the art upon review of the following drawings and detailed description. It is intended that all such additional methods, neuromorphic devices, and related devices be included within this description and protected by the accompanying claims.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates a basic operation of an example neuron circuit model;

FIG. 2 illustrates an example factory use-case where a set of neuromorphic devices (e.g., cameras, vision analysis algorithm, sensors, robotic arm, and control algorithm) use NNs for their operation;

FIG. 3 illustrates rate based and time based neural encoding of spikes, i.e., firing events of one or more neurons of a NN in accordance with some embodiments of inventive concepts;

FIG. 4 illustrates illustrates an HD vector containing symbols with values which are operative to indicate a pattern of firing events for a group of four neurons of a NN, in accordance with some embodiments of inventive concepts;

FIG. 5 illustrates four neuromorphic devices in a wireless communication network, where each of the neuromorphic devices communicate HD vectors which contain symbols indicating whether a firing event occurred for associated neurons of a NN of the neuromorphic device, in accordance with some embodiments;

FIG. 6 illustrates a block diagram of a neuromorphic device (Device A) that includes a NN that is configured to share symbols of an HD vector representing its neuron population activity, in accordance with some embodiments;

FIG. 7 illustrates a flowchart of operations that may be performed by a radio transmitter in accordance with some embodiments;

FIG. 8 illustrates a block diagram of a device that includes a Radio RX Algorithm that is configured to generate an HD vector, based on receiving impulses transmitted by Device A of FIG. 6 and impulses transmitted by any other device(s), for input to a NN, in accordance with some embodiments;

FIG. 9 illustrates a flowchart of operations that may be performed by a radio transmitter in accordance with some embodiments;

FIG. 10 illustrates a radio frame with impulses that have been transmitted by a plurality of transmitters, where each transmitter used a time offset relative to a framesync spike to indicate the symbol value of an HD vector being shared through the transmission, in accordance with some embodiments;

FIG. 11 illustrates a radio frame with impulses that are received by a receiver which identifies impulse time offsets relative to a framesync spike to determine a symbol value of an HD vector being shared through the transmissions, in accordance with some embodiments;

FIG. 12 illustrates OFDM based encoding of three symbol values in the time domain, in accordance with some embodiments;

FIG. 13 illustrates OFDM based encoding of three symbol values in the frequency domain, in accordance with some embodiments

FIG. 14 is a block diagram illustrating a wireless communication device or other user equipment (UE) according to some embodiments of inventive concepts;

FIG. 15 is a block diagram illustrating a radio access network RAN node (e.g., a base station eNB/gNB) according to some embodiments of inventive concepts;

FIG. 16 is a block diagram illustrating a core network CN node (e.g., an AMF node, an SMF node, etc.) according to some embodiments of inventive concepts;

FIG. 17 is a block diagram of a communication system in accordance with some embodiments of inventive concepts;

FIG. 18 is a block diagram of a user equipment in accordance with some embodiments of inventive concepts

FIG. 19 is a block diagram of a network node in accordance with some embodiments of inventive concepts;

FIG. 20 is a block diagram of a host computer communicating with a user equipment in accordance with some embodiments of inventive concepts;

FIG. 21 is a block diagram of a virtualization environment in accordance with some embodiments of inventive concepts; and

FIG. 22 is a block diagram of a host computer communicating via a base station with a user equipment over a partially wireless connection in accordance with some embodiments of inventive concepts.

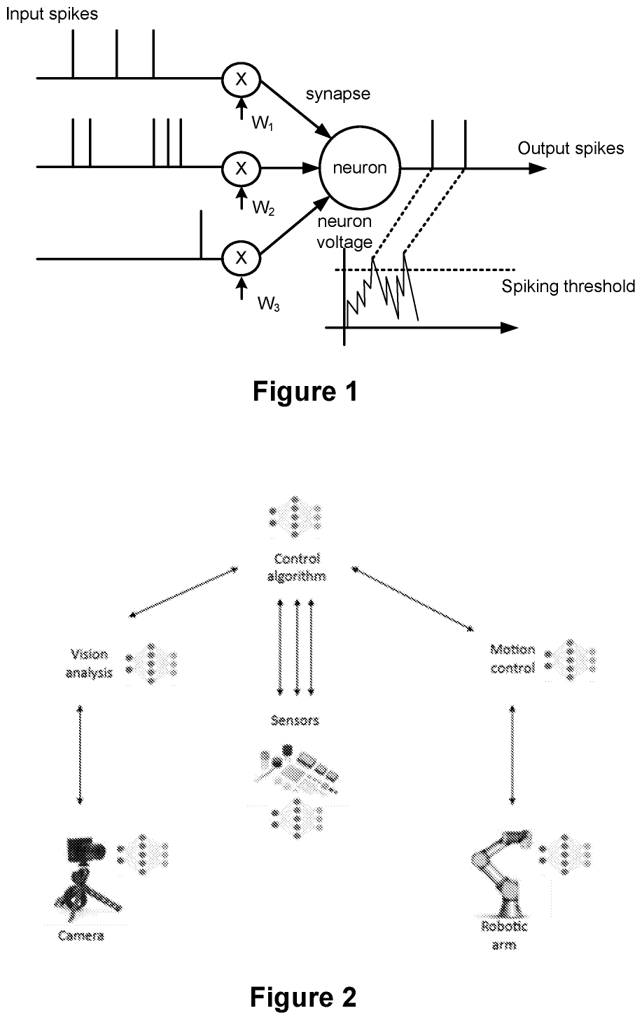

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

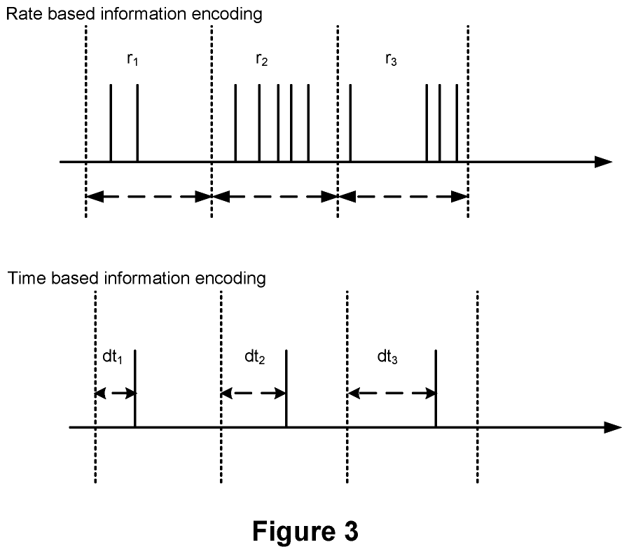

The output information from neurons of a NN, such as SNN, can be encoded either into the rate of spikes or into the timing of individual spikes. FIG. 3 illustrates rate based and time based neural encoding of spikes, i.e., firing events of one or more neurons of a NN. For example, when the spike rate carries the information, then a higher spike rate might be the representation of a larger numerical number. As explained above, a neuron is referred to as having a “firing event” when it operates to an output spike responsive to spikes received on input synapses of the neuron. In case of time based encoding, the relative time between spikes or in relation to some reference may carry information, e.g., a larger relative delay between spikes may indicate a larger encoded numerical value as compared to the first spike. Delay jitters can distort the encoded value and can cause noise and inaccuracies in the neuromorphic system. However, neural representation is typically very robust to noise and errors, for example, in a rate based encoding when a few spikes get lost, it causes like an analogue noise on the decoded data and it degrades smoothly. Note that in case of classical digital encoding the loss of one single bit may cause very large errors and in that sense digital encoded data is not robust at all to bit errors. Another aspect is that the robustness of neural encoding can be gradually increased e.g., by using more neurons to encode a value or by observing the output neural activity for longer times (i.e., applying a longer integration window at the decoder). Thereby, the system can be smoothly optimized for actual communication impairments. In ongoing investigations on the sensitivity of neuromorphic systems to communication impairments, results have shown significant robustness even to very high loss rates, e.g., ×10%.

The situation is similar in time based encoding, however, the robustness and its relation to delays, jitters is somewhat different. The reference time in time based encoding may come from a reference signal, typical in radio communication systems or may be established at the start of each communication instance (e.g., by sending a reference signal before each spike train).

Various embodiments are directed to operations for using Vector Symbolic Architectures (VSA) symbols to encode in the neuromorphic domain the outputs (e.g., firing events) of neurons of a NN to enable wireless communication.

In VSA, symbols are represented by high dimensional vectors. For example, “CAR”=“00011101010010010100101 . . . ”. The number of dimensions can vary between 100-100,000 in practical system implementations. An important property of VSAs is that nearly any two random vectors will be almost perfectly perpendicular to each other—in other words any two random vectors can be differentiated with a very high probability when using a VSA specific similarity metric. Also, if noise is added to the vector, the resulting vector will still be very similar to the original vector even if we add or remove say 30-50% of the bits in the vector. At the same time, due to the high dimensionality, very large number of different symbols can be differentiated without using any coordination, just assigning bits randomly.

An important feature of VSAs is that they allow operations over several vectors to represent complex, multilevel relations between symbols. These operations are called “binding” (⊙), “bundling” (⊕) and “permutation”. For example,

w=JOHN⊙(CAR⊙RED⊕HOUSE⊙YELLOW)

The above operations results in a new vector “w”, which may carry the information that John has a red car and a yellow house. In VSA the resulting “w” vector can have the same dimensionality as all other vectors.

A NN based AI system can represent high-dimensional (HD) vectors, such as VSA vectors, by the combined activity of a neuron population. For example, in . . . 0001101 . . . each digit depicts whether a firing event has occurred for an associated at least one neuron (e.g., is active or not). Using VSA, a NN can store, read, reason, etc. about a vast number of symbols and their relationships within the same limited-size neural population.

Neuromorphic systems typically represent these HD vectors in the form of emitted spike patterns by a group of neurons. In the simplest case of a binary HD vector one neuron per dimension may be sufficient to represent the value of that dimension by emitting a spike when the value of the given vector dimension is 1 otherwise remaining silent without any neural activity. The more general case with non-binary vectors is illustrated in FIG. 4. FIG. 4 illustrates an HD vector containing symbols with values (non-binary values) which are operative to indicate a pattern of firing events for a group of four neurons of a NN. In the illustrated example, a symbol value of 0 indicates that none of the four neurons had a firing event (spike). In contrast, a value of 0.4 indicates indicates a pattern of firing events (spikes) for one or more of the four neurons. A symbol value may, for example, indicate the pattern of concurrent firing events for a group of neurons and/or a pattern of firing events occurring during a defined time duration for an individual neuron or a group of neurons.

Existing technology for packet-based communication is not well suited to interconnect many AI agents to form large, distributed AI systems. One reason is that such technology does not take into account some important VSA properties, including that VSA inherently achieves high level of robustness. Another reason is that VSA can multiplex many independent symbols into the same high-dimensional (HD) vector allowing for more efficient utilization across several concurrent AI-to-AI information exchanges shared on the same radio resource.

Various embodiments are directed to operations for AI agents to transmit HD vectors among each-other, such as in a one-to-many pattern or a many-to-many pattern. These embodiments may be very beneficial for concurrent transmissions performed over the same radio resources, e.g., channel, and when the symbols of the HD vector encode non-binary high-dimensional spaces. A transmitter circuit can operate to efficiently transmit such symbols using short impulses over Ultra Wide Band physical layer by encoding information in a sequence of precisely timed impulses. Such transmitters may use other types of radio technologies, e.g., Orthogonal Frequency Division Multiplexing (OFDM). A receiver circuit operates to combine the received impulses mixed from multiple transmitters using an over-the-air computation operation that allows to decode information even when multiple transmitters use the same same radio resources, e.g., channel. The operations can be very resilient to errors due to VSA encoding and allow for low power operation by only switching on receiver circuitry and transmitter circuitry for very short periods of time, in some embodiments.

These embodiments may be fully compatible with neuromorphic devices, to the extent that large part of the operations can be implemented as NNs avoiding the necessity to translate between neuromorphic and non-AI data representations and APIs. Various embodiments are directed to operations incorporated into various types of radio access schemes and protocol stacks for TDM, OFDM, and wide-band impulse radios.

HD vectors containing symbolic neural information can be efficiently shared through a radio resource across multiple neuromorphic devices natively.

Various operations which provide a High Dimensional (HD) space as a shared information channel in a distributed neuromorphic system are now described in accordance with some embodiments.

HD computing together with VSA makes it possible to map vast number of different symbols representing information to a single HD space with very low probability of collisions between the symbols. Some embodiments may arise from the present realization that VSA can be used as a common language for communications among neuromorphic computing devices. Thus, instead of translating neural information to digital domain or using raw spike-to-radio encodings, various embodiments disclosed herein use VSA as the common format. The VSA format is more compact than the raw neural patterns, but can still be considered neuromorphic domain, because the mapping between a neural population activity pattern and the corresponding VSA vector is both simple and fast.

For example, various devices may communicate VSA as follows: Device A→VSA1→Device B→VSA2→Device C

Without more, a potential disadvantage of communicating VSA format in the above example is that it would still require independent VSA radio communication channels VSA1 and VSA2.

In accordance with some operational methods, the radio interface computes a VSA bundling operator. A potential benefit is that the devices can transmit on the same radio channel simultaneously while enabling decoding of the VSA vectors.

FIG. 4 illustrates four neuromorphic devices (Device A, Device B, Device C, and Device D) in a wireless communication network, where each of the neuromorphic devices communicates HD vectors which contain symbols, and at least some of the symbols have a value operative to indicate a pattern of firing events for associated one or more neurons of a NN. Moreover, each of the neuromorphic devices may operate to, for each symbol in the HD vector having a nonzero value, select a subframe of a radio frame and/or a carrier frequency among a set of carrier frequencies, based on a defined mapping between subframes of the radio frame and/or carrier frequencies of the set and the locations of symbols in the HD vector. The operations determine a time offset relative to the selected subframe and/or a frequency offset relative to the selected carrier frequency, based on the value of the symbol. The operations then transmit an impulse at the determined time offset relative to the selected subframe and/or at the determined frequency offset relative to the selected carrier frequency. The four neuromorphic devices may concurrently transmit symbols of their respective HD vectors using a shared radio resource element(s). The receiving device(s) can decode the transmissions even when they are mixed from multiple transmissions by using a form of over-the-air combining of the impulses and then decoding the individual vectors using VSA operations.

Potential advantages of one or more of the embodiments of the present disclosure are described below.

VSA encoding is a general-purpose encoding of symbols, concepts etc. in neuromorphic computing. In accordance with various embodiments of the present disclosure, a neuromorphic device can more seamlessly communicate with other neuromorphic devices without exiting the neuromorphic computation domain.

Various disclosed embodiments can provide robustness against noise and interference by the VSA operations, thus the radio circuit may be configured to implement only relatively simple algorithms (e.g., simplified modulation, no or simplified channel equalization, no retransmissions, etc.), and which may use a new radio protocol stack design. The receiver (RX) and transmitter (TX) VSA operations can be fully neuromorphic compatible, so they can be performed in native neuromorphic computing (NC) domain.

If the receiver knows the acceptable symbol(s) (e.g., its address, or even a complex bundled structure and/or dimensions of interest in the full symbol received), the receiver only needs to listen on those specific subframes. In case of SDR-VSMA, this means that the receiver may only need to listen 1% of the time to fully decode a VSA symbol. These operations enable use of very low power radio receivers.

By using very short UWB impulses, and encoding information not in the impulse but in the timing of impulses and/or carrier frequency offset of impulses, a very large amount of information can be encoded with very little transmission power.

A similar benefit is obtained on the receiver side, because the receiver circuit may be configured to only listen to the exact times it expects to receive impulses (e.g., symbols that it is interested in), which reduces power consumption of the receiver circuit.

Both the TX and RX circuits can be implemented in very efficient and low power neuromorphic computing. The radio circuits can thus be very simple. For example, a radio circuit can be configured to only transmit and receive impulses at certain times relative to a frame synchronization event (frame sync). The complete radio stack can be relatively simple, for example, because there is no need to use device (e.g., UE) identities or resource allocation on the radio interface. Power control can also be very simple and coarsely timed.

Various present embodiments may enable multiplexing many TX streams onto a single RX receiver channel, where the number of transmitting TX sources can vary dynamically, even from one frame to the other without explicit signaling. The overhead of multiple access management is minimized in this system.

Various RX and/or TX algorithms disclosed herein can be mapped onto various physical layers. Although three example operational methods are described in detail, the operational methods can be implemented over further physical layers without limitation to the particular embodiments disclosed herein. The OFDM variant can potentially co-exist with other OFDM based technologies (e.g., 3GPP).

A high level overview of various neuromorphic multiple access schemes is now described in accordance with some embodiments.

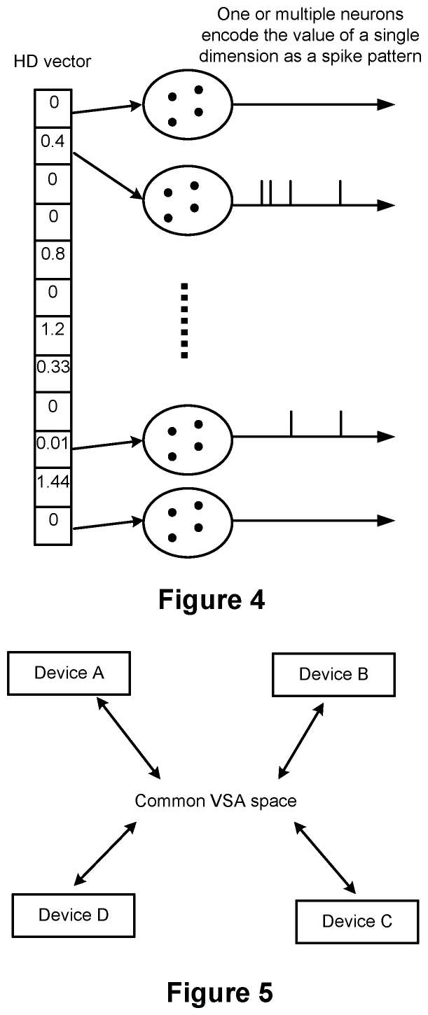

Various operations build on top of VSA approaches to allow communication among multiple AI agents over radio, e.g., Devices A, B, C, D in FIG. 5, in accordance with some embodiments.

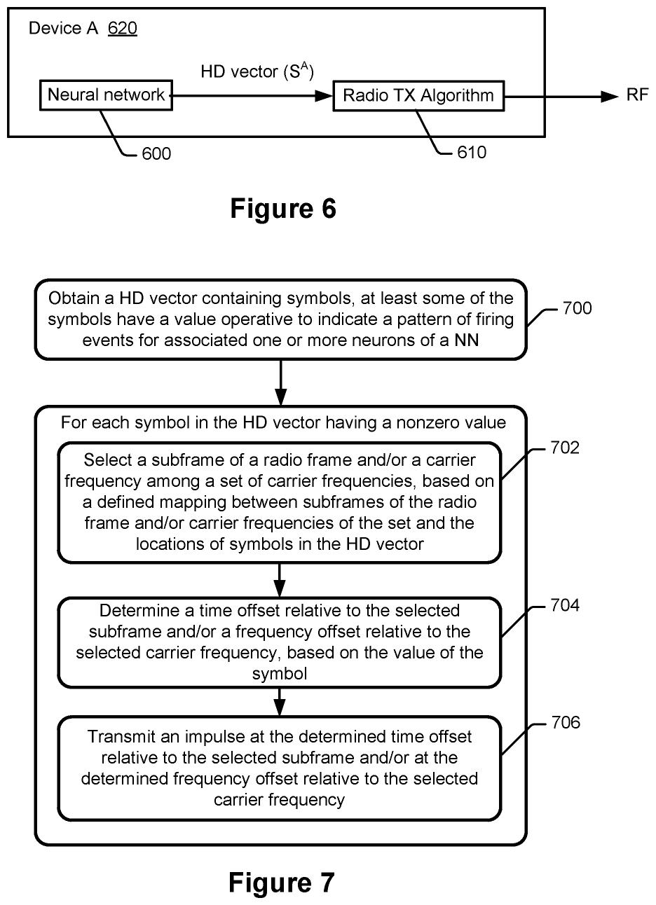

Operations that can be performed by a radio transmitter are now explained with reference to FIGS. 6, 7, and 10.

FIG. 6 illustrates a block diagram of a neuromorphic device 620 (Device A) that includes a NN 600 that is configured to share a HD vector representing its neuron firing event activity with one or more other devices, which as described below may be one or more other neuromorphic devices or may be a base station for relay to one or more neuromorphic devices. The neuron firing event activity can be represented as a high-dimensional (HD) vector (S^{A}). The HD vector contains symbols indicating whether a firing event occurred for associated neurons of the NN 600. A Radio TX Algorithm (RTXA) 610 processes the HD vector to controls RF transmissions. Multiple such devices may concurrently operate to share their respective internal HD vector representations (S^{A}, S^{B}, . . . ), where “A” corresponds to “Device A”, “B” corresponds to “Device B”, etc. The RTXA 610 operates to transmit indications of symbols in the HD vectors indicating patterns of firing events using radio resource element(s), e.g., radio channel, in accordance with various embodiments disclosed herein.

The radio transmitter (e.g., RTXA 610) obtains the VSA encoded symbol as a vector of real-valued dimensions (S).

S=[v₁,v₂, . . . v_{N}]

The symbol values vi can be real or integer valued. The operations can also be extended to operate with complex valued symbols. The terms symbol and dimension can be used interchangeably herein.

All transmitters synchronize to a common Frame Sync. The radio frame has a defined length and is subdivided into N subframes, one subframe for each symbol location (dimension) in the VSA HD vector, i.e., each symbol location is mapped to a different subframe of the radio frame.

For each non-zero valued symbol, the transmitter then transmits a short impulse within the respective subframe such that the relative position within the subframe is a function of the symbol value:

Ti=F(vᵢ)

The simplest suitable F function is a linear function that maps possible v values to fall within the period of the subframe.

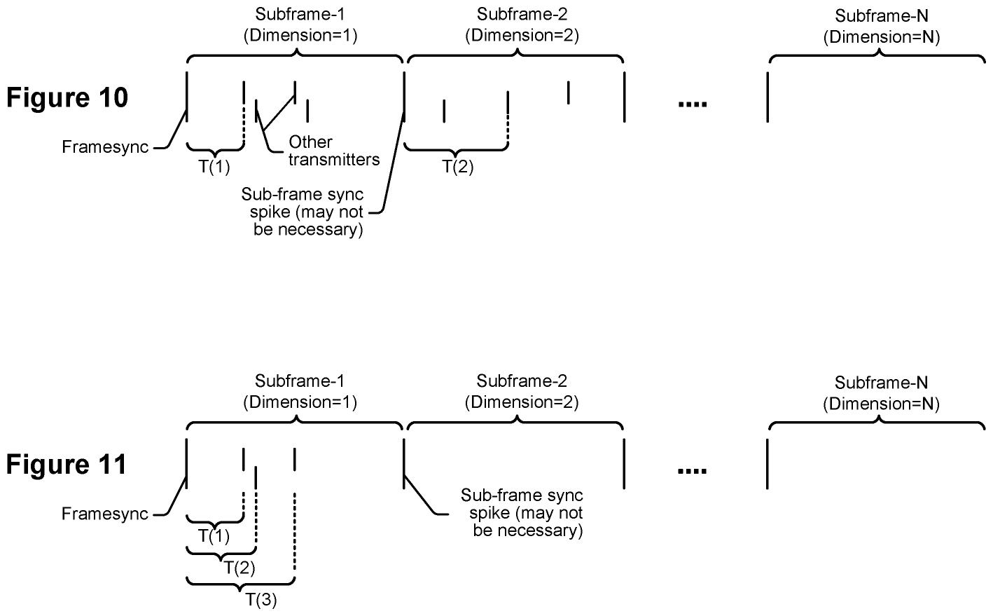

FIG. 10 illustrates a radio frame with impulses that have been transmitted by a plurality of transmitters, where each transmitter computed (determined) a time offset relative to a framesync spike for transmitting the impulse to indicate the corresponding symbol value of an HD vector being shared through the transmission, in accordance with some embodiments. In the illustrated example, Subframe-1 (mapped to symbol location (dimension) 1 in a HD vector) of a radio frame contains four impulses transmitted by respective four transmitters, with one of the impulses having a time offset of T(1). Another Subframe-2 (mapped to symbol location (dimension) 1 in a HD vector) of the radio frame contains three impulses transmitted by three transmitters, with one of the impulses having of time offset T(2) relative to the sub-frame sync. FIG. 10 shows sub-frame sync spikes which may be needed to enable transmitters to perform sufficiently accurate timing of impulse transmissions in case of long frame sizes.

In some embodiments, symbols having a zero value are not transmitted. By using VSA encodings with many zero values (sparse HD vectors), this can be used to enable reduction in the energy consumption of the transmitters and corresponding receivers. Although symbols having a zero value may not be transmitted to, for example, reduce power consumption and improve radio efficiency, the zero value symbols hold information which the receiver will infer when generating a local HD vector based on receipt and lack of receipt of impulses in various subframes.

Because multiple transmitters synchronize to the same Frame Sync (“frame synchronization event”), there may be a plurality of impulses within some subframes. It is noted that impulses have no identity in that they cannot be differentiated to identify the transmitter. As will be explained below, the receiver algorithm does not need to know the identity of which transmitter transmitted which impulse.

Multipath effects and collisions from multiple transmitters may cause spurious impulse detections and lost impulses, these and other errors are compensated for through the redundant nature of the VSA encoding. Such errors appear as noise in VSA.

FIG. 7 illustrates a flowchart of corresponding operations that may be performed by the RTXA 610, in accordance with some embodiments. Referring to FIG. 7, the RTXA 610 obtains 700 a high dimensional (HD) vector containing symbols, wherein at least some of the symbols have a value operative to indicate a pattern of firing events for associated one or more neurons of the NN 600. For each symbol in the HD vector having a nonzero value, the RTXA 610 selects 702 a subframe of a radio frame and/or a carrier frequency among a set of carrier frequencies, based on a defined mapping between subframes of the radio frame and/or carrier frequencies of the set and the locations of symbols in the HD vector. The RTXA 610 determines 704 a time offset relative to the selected subframe and/or a frequency offset relative to the selected carrier frequency, based on the value of the symbol. The RTXA 610 transmits 706 an impulse at the determined time offset relative to the selected subframe and/or at the determined frequency offset relative to the selected carrier frequency.

As explained above, in one further embodiment the device does not transmit an impulse for any symbol in the HD vector having a zero value.

In a further embodiment, the operation to determine 704 determines a value of the time offset and/or a value of the frequency offset based on processing the value of the symbol through a linear function that maps symbol values to time offset values and/or to frequency offset values.

In a further embodiment, the selecting operation 702 selects the subframe of the radio frame based on the defined mapping between subframes of the radio frame and the locations of symbols in the HD vector. The determining operation 704 determines the time offset relative to the selected subframe based on the value of the symbol. The transmitting operation 706 transmits the impulse at the determined time offset relative to the selected subframe.

In a further embodiment, each of a plurality of neuromorphic devices may be assigned to different individual slots within each subframe for possibly transmitting an impulse. Corresponding operations can include determining an assignment of the neuromorphic device to one of a plurality of slots in the subframe of the radio frame. The transmitting operation 706 transmits the impulse at the determined time offset in the one of the slots.

In a further embodiment, neuromorphic devices may randomly select among slots within each subframe for possibly transmitting an impulse. Corresponding operations can include, for each symbol in the HD vector having a nonzero value, randomly selecting one of a plurality of slots in the subframe of the radio frame. The transmitting operation 706 transmits the impulse at the determined time offset in the one of the slots.

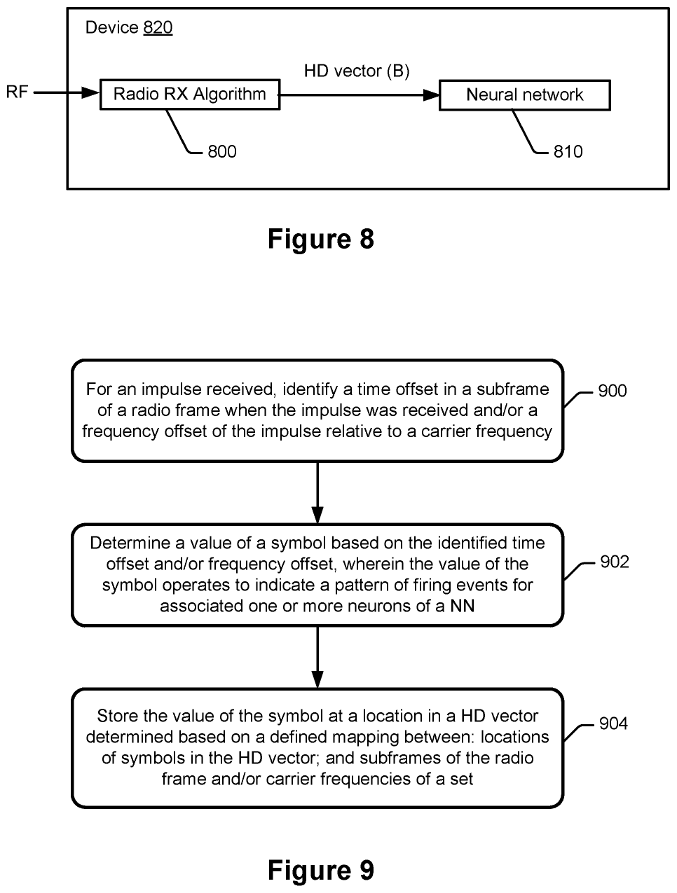

Operations that can be performed by a radio receiver are now explained with reference to FIGS. 8, 9, and 11.

FIG. 8 illustrates a block diagram of a device 820 that includes a Radio RX Algorithm (RRXA) 800 that is configured to generate (construct) an HD vector (B), based on receiving impulses transmitted by Device A 620 of FIG. 6 and impulses transmitted by any other device(s), for input to a NN 810, in accordance with some embodiments. On the receiver side, the RRXA 800 listens to the RF channel and generates the HD vector (B), which is a derivation of all transmitting devices' HD vectors (S) created by the RTXA 610 in the other devices, including Device A 620 of FIG. 5. The HD vector (B) contains symbols having a value operative to indicate a pattern of firing events for associated one or more neurons of the NN 600 of Device A along with the pattern of firing events for associated one or more neurons of NN(s) of any other device(s) transmitting impulses, and is used as inputs to neurons of the NN 810 of device 820.

The receiver (RRXA 800) synchronizes to the Frame Sync and identifies a time offset relative to the Frame Sync (frame synchronization event) for each impulse it detects. The RRXA 800 determines 902 a value of a symbol based on the identified time offset, and stores the value of the symbol at a location in a HD vector determined based on a defined mapping between locations of symbols in the HD vector and subframes of the radio frame. The RRXA 800 may receive (detect) impulses using a threshold-based detection which facilitates a low complexity implementation.

When there are multiple transmissions, the RRXA 800 will probably detect multiple impulses within a subframe. The receiver combines these impulses to determine a single value (real, integer, or complex) for the symbol being shared by the multiple transmitters.

FIG. 11 illustrates a radio frame with impulses that are received by the RRXA 800 which identifies impulse time offsets relative to a framesync spike to determine a symbol value of an HD vector being shared through the transmissions, in accordance with some embodiments. In the illustrated example, the RRXA 800 receives three spikes having respective delays T(1), T(2), (T3) in subframe-1.

The TX and RX algorithms can be configured such that the received HD vector B and the transmitted HD vectors S^{A}, S^{B}, . . . vectors will have the following relationship:

$$B = {S}^{A} ⊕ {S}^{B} ⊕ {S}^{C} ⊕ …$$

The operator ⊕ is the VSA bundle operator. It is noted that the above relationship may include a noise term or error relating to detection.

In this manner, the TX and RX algorithms can operate to create an AI centric multiple access scheme for distributed AI agents to efficiently share arbitrary, complex symbolic information that can be further processed, queried, etc. using VSA operations.

Various embodiments are directed to two different approaches which are both compatible with VSA architectures:
1) Sum up all time offsets (also called delays) within subframes: T=SUM(Tⱼ); or
2) Consider time offsets as phases and sum up all phases (modulo based), e.g.: Tᵢ=MOD(SUM(dᵢ), PERIOD)

The first approach operates to determine a symbol value based on summing all time offsets. The operations compute a summed time offset T based on SUM(Tⱼ), and then determine the symbol value based on the summed time offset T. The first approach can be used with Holographic Reduced Representation (HRR). The second approach can be used together with Holographic Reduced Representation in the Frequency Domain (FHRR).

To determine the symbol value, the receiver may operate to translate the summed time offset T based on the following equation:

$$V = {F}^{- 1} ( T )$$

After resolving any number of impulses within subframes, the receiver determines a single value for each subframe. The receiver adds the symbol value to a location in the HD vector R corresponding to the particular subframe, such as based on the following:

R=[v₁,v₂, . . . v_{N}]

When this algorithm is applied, the HD vector R contains symbols representing VSA bundling of all transmissions Sᵢ including possible errors. Operator ⊕ denotes the VSA bundle operation.

$$R ∼ {S}_{1} ⊕ {S}_{2} ⊕ …$$

The receiver can then use VSA operations to manipulate the vector.

FIG. 9 illustrates a flowchart of some corresponding operations that may be performed by a radio receiver (RRXA 800) in accordance with some embodiments. Referring to FIG. 9, for an impulse that was received, the receiver identifies 900 a time offset in a subframe of a radio frame when the impulse was received and/or a frequency offset of the impulse relative to a carrier frequency. The receiver determines 902 a value of a symbol based on the identified time offset and/or frequency offset, wherein the value of the symbol operates to indicate a pattern of firing events for associated one or more neurons of the NN 600, e.g., of Device A 620. The receiver stores 904 the value of the symbol at a location in a HD vector determined based on a defined mapping between: locations of symbols in the HD vector; and subframes of the radio frame and/or carrier frequencies of a set.

In a further embodiment, the determining operation 902 determines a value of the symbol based on processing the determined time offset through a linear function that maps symbol values to time offset values and/or to frequency offset values.

In a further embodiment, the identifying operation 900 identifies the time offset in the subframe of the radio frame when the impulse was received. The determining operation 902 determines the value of the symbol based on the identified time offset. The storing operation 904 stores the value of the symbol at the location in the HD vector determined based on the defined mapping between locations of symbols in the HD vector and the subframes of the radio frame.

In a further embodiment directed to the first approach, the operations repeat the identifying 900 for a plurality of impulses received in the subframe of the radio frame. The determining operation 902 determines the value of the symbol based on combining the identified time offsets. As explained above, the combining can include summing the identified time offsets.

In a further embodiment directed to the first approach, the time offset is a phase, and the operations repeat the identifying 900 for a plurality of impulses received in the subframe of the radio frame. The determining operation 902 determines the value of the symbol based on combining the phases of the plurality of impulses.

Some embodiments are directed to reducing power consumption of the receiver. When the receiver knows the symbol(s) it wants to listen to, it can operate to switch on (e.g., powered-on or switched from a lower-power to higher-power state) its receiver circuit at the exact times possible impulses can be present in the expected vector S. All other transmissions can be neglected by powering-off the receiver circuit or switching from a higher-power to lower-power state. Since information is encoded in time offsets (delays) and not in the impulse itself, the presence of an impulse at an exact sequence of times can encode a relatively large amount of information although the total time used for radio communication is relatively low, due to fact that ultra-wide band (UWB) impulses can be very short (e.g., 1 ns).

Various orthogonal frequency-division multiplexing (OFDM) implementations are now described in accordance with some embodiments.

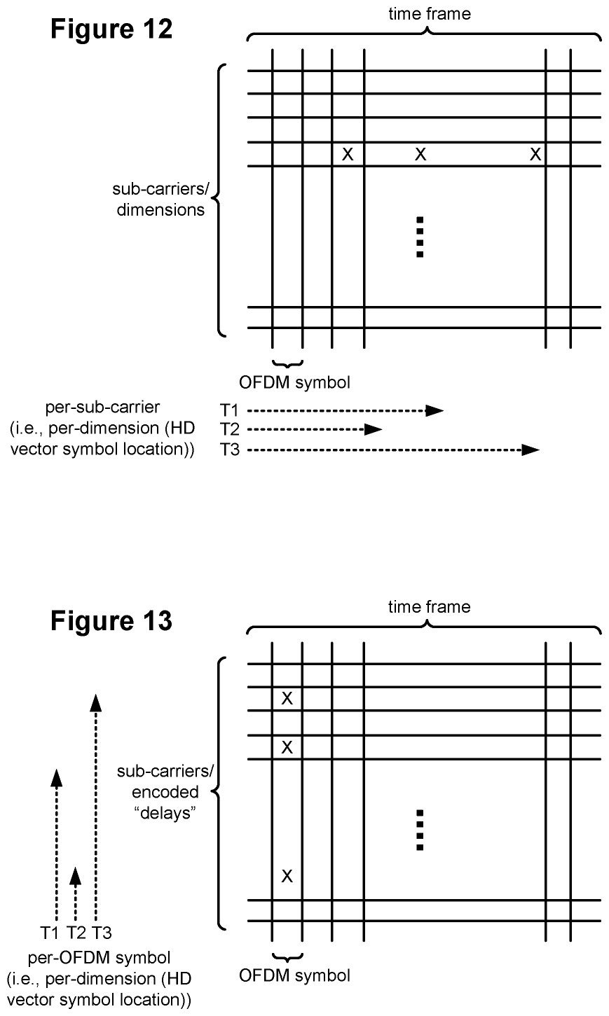

Similar encoding approaches described above can be implemented and mapped to an OFDM based radio link. For OFDM, each vector symbol location (dimension) can be mapped to one sub-carrier (also referred to as carrier) in the frequency domain. In the time domain multiple OFDM symbols can be grouped into a frame, where a delay encoded value can be mapped into one of these OFDM symbols within the frame depending on the actual symbol value being encoded. An example mapping is illustrated in FIG. 12. FIG. 12 illustrates OFDM based encoding of three symbol values in the time domain, in accordance with some embodiments. The illustrated “X”s indicate impulses transmitted by three transmitters, where the impulses have respective time offsets T1, T2, T3. The different time offsets T1, T2, T3 indicate that the three symbol values communicated by the three transmitters are different.

The OFDM symbols can be chosen as short as possible to improve the delay resolution, which will eventually be dependent on the available bandwidth and the number of dimensions (i.e., sub-carriers) that are to be encoded.

Another approach is to encode symbol values into the OFDM structure by encoding the symbol values as distances in the sub-carrier space i.e., into the frequency domain. For a received impulse, a receive can identify a frequency offset of the impulse relative to a carrier frequency. FIG. 13 illustrates OFDM based encoding of three symbol values in the frequency domain, in accordance with some embodiments. In this case, each OFDM symbol corresponds to one of the vector dimensions and the delay values are encoded as relative distances in the sub-carrier space. The illustrated “X”s indicate impulses transmitted by three transmitters, where the impulses have respective frequency offsets. The frequency offsets indicate that the three symbol values communicated by the three transmitters are different.

Finally, any combination of the two approaches of encoding can be performed. For example, the time-frequency OFDM grid can be viewed as a flattened array and the HD vector symbol locations (dimensions) and delay values could be continuously mapped into this 1D array.

As compared to the UWB approach, the symbol time of OFDM is longer than an UWB impulse, however, in the OFDM solution all (or multiple) dimensions can be transmitted at the same time. Another advantage of the OFDM approach can be the easier compatibility and integration into existing or future OFDM based cellular radio interfaces. For example, certain time slots might be dedicated to VSA encoded transmissions in a 3GPP 5G and/or 6G radio interface, while the rest of the slots can be used as for regular data transmission.

Corresponding operations by a transmitter can include, the selecting operation 702 selects the carrier frequency among the set of carrier frequencies based on the defined mapping between carrier frequencies of the set and the locations of symbols in the HD vector. The determining operation 704 determines the frequency offset relative to the selected carrier frequency based on the value of the symbol. The transmitting operation 706 transmits the impulse at the determined frequency offset relative to the selected carrier frequency.

Corresponding operations by a receiver can include where the identifying operation 900 identifies the frequency offset of the impulse relative to the carrier frequency. The determining operation 902 determines the value of the symbol based on the identified frequency offset. The storing operation 904 stores the value of the symbol at the location in the HD vector determined based on the defined mapping between locations of symbols in the HD vector and the carrier frequencies of the set.

In a further embodiment directed to OFDM bundling, the receiver can repeat the identifying 900 for a plurality of impulses received in the subframe of the radio frame. The determining operation 902 determines the value of the symbol based on combining the identified frequency offsets. As explained above, the combining can include summing the identified frequency offsets.

Various corresponding operations that can be performance by a base station are now described in the context of some embodiments.

A base station (BS) function can be configured to perform operations according to various embodiments, such as those explained with reference to FIGS. 8, 9, 11, 12, and 13. The BS may identify 900 time offsets of impulses received in subframes in an uplink direction from transmitting neuromorphic devices. The BS determines 902 values of symbols to be stored 905 at locations in an HD vector mapped to the subframes in which the respective symbol values were determined 902. Then the BS retransmits the resulting, possibly “thinned”, HD vector in a downlink direction. The allocated downlink radio resource(s) (e.g., channel(s)) which are used by the BS for downlink communication of the generated HD vector may have a much lower capacity than are used for uplink communications by the neuromorphic devices.

Neuromorphic devices may then only need to listen for the BS downlink transmissions and not, for example, on the same radio channel used by all neuromorphic devices to transmit. In other words, the neuromorphic devices may ignore transmissions by other neuromorphic devices and instead listen for downlink transmissions by the BS. This has the benefit of devices requiring less power for reception, since the downlink channel is smaller than the uplink channel.

Moreover, the BS may operate to forward the received symbols as the combined VSA HD vector to areas out of reach to certain neuromorphic devices (e.g., a device which is not able to otherwise able to detect transmissions by one or more other of the devices). If several BSs receive vectors independently, the BSs may bundle their vectors together (“hierarchical bundling”), e.g., via inter-BS communications, into a combined vector and then transmit the combined vector downstream effectively broadcasting all the symbols received across a larger multi-BS coverage area.

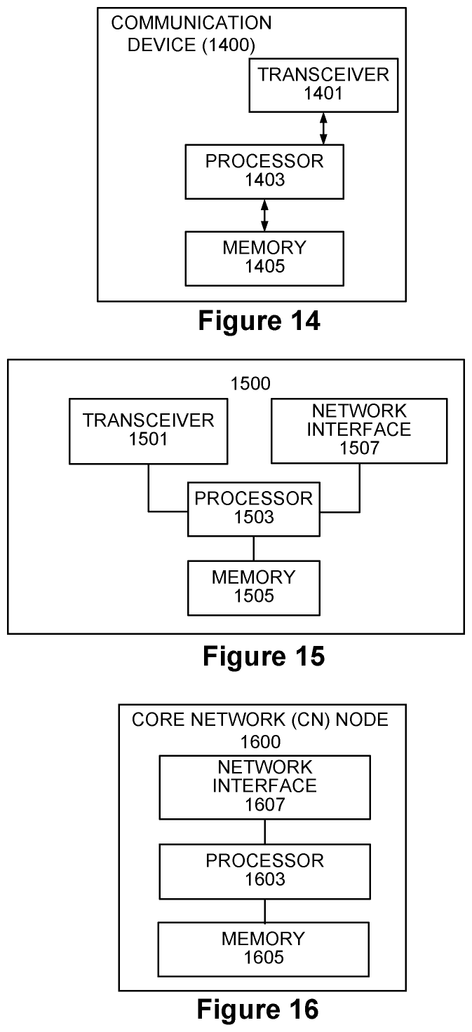

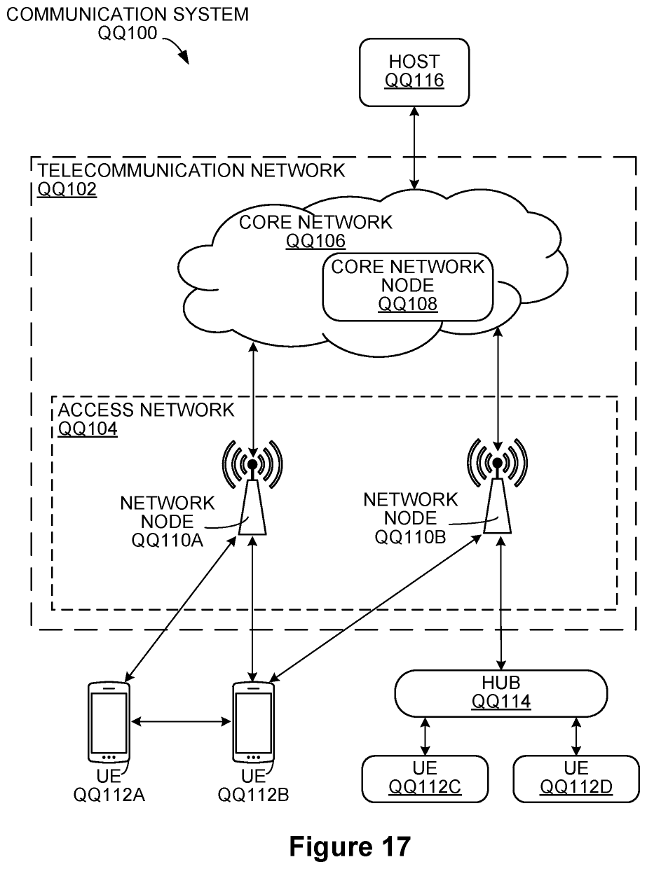

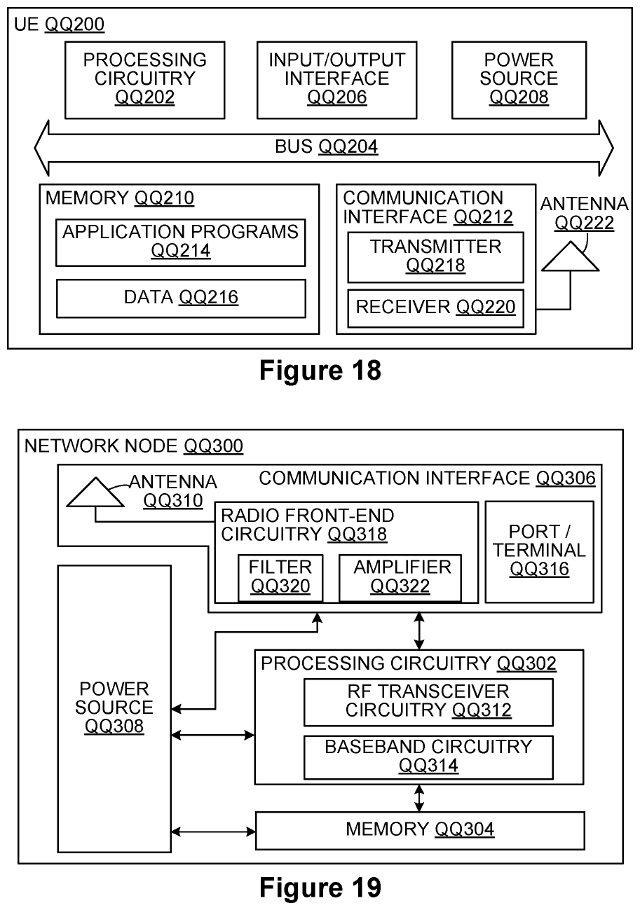

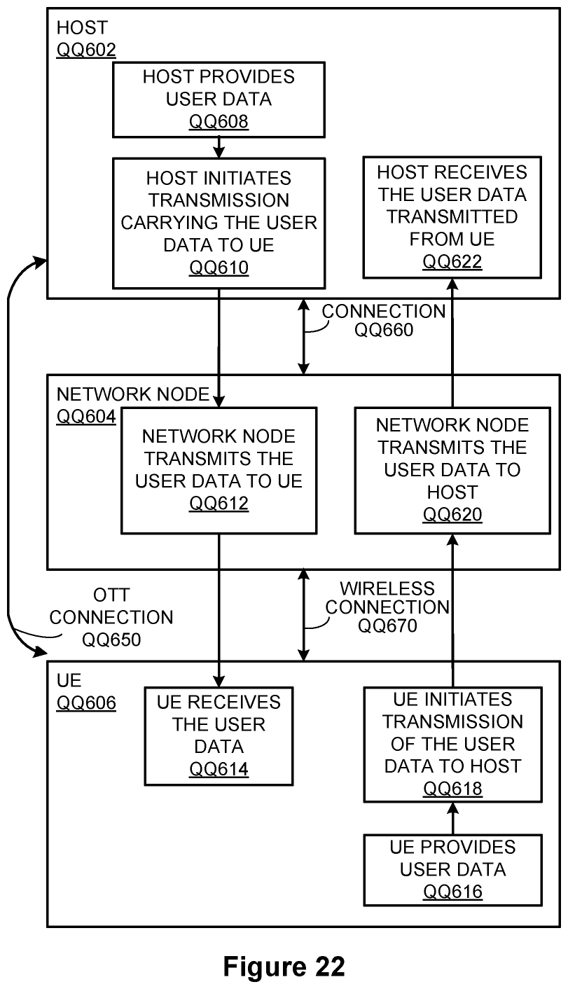

FIG. 14 is a block diagram illustrating elements of a communication device 1400 which may correspond to various neuromorphic devices disclosed herein, such as the device 620 of FIG. 6. The communication device is also referred to as a mobile terminal, a mobile communication terminal, a wireless device, a wireless communication device, a wireless terminal, mobile device, a device, a wireless communication terminal, user equipment (UE), a user equipment node/terminal/device, etc.) configured to provide wireless communication according to embodiments of inventive concepts. (Communication device 1400 may be provided, for example, as discussed below with respect to wireless devices UE QQ112A, UE QQ112B, and wired or wireless devices UE QQ112C, UE QQ112D of FIG. 17, UE QQ200 of FIG. 18, virtualization hardware QQ504 and virtual machines QQ508A, QQ508B of FIG. 21, and UE QQ606 of FIG. 22, all of which should be considered interchangeable in the examples and embodiments described herein and be within the intended scope of this disclosure, unless otherwise noted.) As shown, communication device may include one or more antenna(s) (e.g., corresponding to antenna QQ222 of FIG. 18), and transceiver circuitry 1401 (also referred to as a transceiver, e.g., corresponding to interface QQ212 of FIG. 18 having transmitter QQ218 and receiver QQ220) including a transmitter and a receiver configured to provide uplink and downlink radio communications with another communication device and/or a base station(s) (e.g., corresponding to network node QQ110A, QQ110B of FIG. 17, network node QQ300 of FIG. 19, and network node QQ604 of FIG. 22 also referred to as a RAN node) of a radio access network. Communication device 1400 may also include processing circuitry 1403 (also referred to as a processor, e.g., corresponding to processing circuitry QQ202 of FIG. 18, and control system QQ512 of FIG. 21) coupled to the transceiver circuitry, and memory circuitry 1405 (also referred to as memory, e.g., corresponding to memory QQ210 of FIG. 17) coupled to the processing circuitry. The memory circuitry 1405 may include computer readable program code that when executed by the processing circuitry 1403 causes the processing circuitry to perform operations according to embodiments disclosed herein. According to other embodiments, processing circuitry 1403 may be defined to include memory so that separate memory circuitry is not required. Communication device 1400 may also include an interface (such as a user interface) coupled with processing circuitry 1403, and/or communication device 1400 may be incorporated in a vehicle.

As discussed herein, operations of communication device 1400 may be performed by processing circuitry 1403 and/or transceiver circuitry 1401. For example, processing circuitry 1403 may control transceiver circuitry 1401 to transmit communications through transceiver circuitry 1401 over a radio interface to a radio access network node (also referred to as a base station) and/or to receive communications through transceiver circuitry 1401 from a RAN node over a radio interface. Moreover, modules may be stored in memory circuitry 1405, and these modules may provide instructions so that when instructions of a module are executed by processing circuitry 1403, processing circuitry 1403 performs respective operations (e.g., operations discussed below with respect to Example Embodiments relating to wireless communication devices and wireless communication network nodes). According to some embodiments, a communication device 1400 and/or an element(s)/function(s) thereof may be embodied as a virtual node/nodes and/or a virtual machine/machines. Various operations by the communication device 1400 in accordance with embodiments of the present disclosure may be performed by discrete logic circuitry, analog circuitry, and/or hybrid circuitry. The circuitry may include an application-specific integrated circuit (ASIC), which may include a field programmable gate array (FPGA), neural processing unit (NPU), etc., or may be performed by a central processing unit (CPU), a graphics processing unit (GPU), a line card, etc.

FIG. 15 is a block diagram illustrating elements of a radio access network RAN node 1500 (also referred to as a network node, base station (BS), eNodeB/eNB, gNodeB/gNB, etc.) of a Radio Access Network (RAN) configured to provide cellular communication according to embodiments of inventive concepts. (RAN node 1500 may be provided, for example, as discussed below with respect to network node QQ110A, QQ110B of FIG. 17, network node QQ300 of FIG. 19, hardware QQ504 or virtual machine QQ508A, QQ508B of FIG. 21, and/or base station QQ604 of FIG. 22, all of which should be considered interchangeable in the examples and embodiments described herein and be within the intended scope of this disclosure, unless otherwise noted.) As shown, the RAN node may include transceiver circuitry 1501 (also referred to as a transceiver, e.g., corresponding to portions of RF transceiver circuitry QQ312 and radio front end circuitry QQ318 of FIG. 19) including a transmitter which transmits through one or more antenna(s) (e.g., MIMO configured plurality of antennas) and a receiver configured to provide uplink and downlink radio communications with mobile terminals. The RAN node may include network interface circuitry 1507 (also referred to as a network interface, e.g., corresponding to portions of communication interface QQ306 of FIG. 19) configured to provide communications with other nodes (e.g., with other base stations) of the RAN and/or core network CN. The network node may also include processing circuitry 1503 (also referred to as a processor, e.g., corresponding to processing circuitry QQ302 of FIG. 19) coupled to the transceiver circuitry, and memory circuitry 1505 (also referred to as memory, e.g., corresponding to memory QQ304 of FIG. 19) coupled to the processing circuitry. The memory circuitry 1505 may include computer readable program code that when executed by the processing circuitry 1503 causes the processing circuitry to perform operations according to embodiments disclosed herein. According to other embodiments, processing circuitry 1503 may be defined to include memory so that a separate memory circuitry is not required. Various operations by the RAN node in accordance with embodiments of the present disclosure may be performed by discrete logic circuitry, analog circuitry, and/or hybrid circuitry. The RAN node may perform according to one or more embodiments disclosed herein for a neuromorphic device and/or a base station which communicates with one or more neuromorphic devices.

As discussed herein, operations of the RAN node 1500 may be performed by processing circuitry 1503, network interface 1507, and/or transceiver 1501. For example, processing circuitry 1503 may control transceiver 1507 to transmit downlink communications through transceiver 1501 over a radio interface to one or more communication devices 1400 and/or to receive uplink communications through transceiver 1501 from one or more communication devices 1400 over a radio interface. Similarly, processing circuitry 1503 may control network interface 1507 to transmit communications through network interface 1507 to one or more other network nodes and/or to receive communications through network interface from one or more other network nodes. Moreover, modules may be stored in memory 1505, and these modules may provide instructions so that when instructions of a module are executed by processing circuitry 1503, processing circuitry 1503 performs respective operations (e.g., operations discussed below with respect to Example Embodiments relating to RAN nodes). According to some embodiments, RAN node 1500 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device may be initiated by the network node so that transmission to the wireless communication device is provided through a network node including a transceiver (e.g., through a base station or RAN node). According to embodiments where the network node is a RAN node including a transceiver, initiating transmission may include transmitting through the transceiver.

FIG. 16 is a block diagram illustrating elements of a core network (CN) node 1600 of a communication network configured to provide cellular communication according to embodiments of inventive concepts. (CN node 1600 may be provided, for example, as discussed below with respect to core network node QQ108 of FIG. 17, hardware QQ504 or virtual machine QQ508A, QQ508B of FIG. 21, all of which should be considered interchangeable in the examples and embodiments described herein and be within the intended scope of this disclosure, unless otherwise noted) As shown, the CN node may include network interface circuitry 1607 configured to provide communications with other nodes of the core network and/or the radio access network RAN. The CN node may also include a processing circuitry 1607 (also referred to as a processor,) coupled to the network interface circuitry, and memory circuitry 1605 (also referred to as memory) coupled to the processing circuitry. The memory circuitry 1605 may include computer readable program code that when executed by the processing circuitry 1603 causes the processing circuitry to perform operations according to embodiments disclosed herein. According to other embodiments, processing circuitry 1603 may be defined to include memory so that a separate memory circuitry is not required.

The CN node 1600 may perform according to one or more embodiments disclosed herein for a neuromorphic device and/or other device which communicates with one or more neuromorphic devices. As discussed herein, operations of the CN node 1600 may be performed by processing circuitry 1603 and/or network interface circuitry 1607. For example, processing circuitry 1603 may control network interface circuitry 1607 to transmit communications through network interface circuitry 1607 to one or more other network nodes and/or to receive communications through network interface circuitry from one or more other network nodes. Moreover, modules may be stored in memory 1605, and these modules may provide instructions so that when instructions of a module are executed by processing circuitry 1603, processing circuitry 1603 performs respective operations (e.g., operations discussed below with respect to Example Embodiments relating to core network nodes). According to some embodiments, CN node 1600 and/or an element(s)/function(s) thereof may be embodied as a virtual node/nodes and/or a virtual machine/machines. Various operations by the CN node 1600 in accordance with the present disclosure may be performed by discrete logic such as a FPGA.

FIG. 17 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 18 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as “SIM card.” The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation. In practice, any number of UEs may be used together with respect to a single use case.

FIG. 19 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 19 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

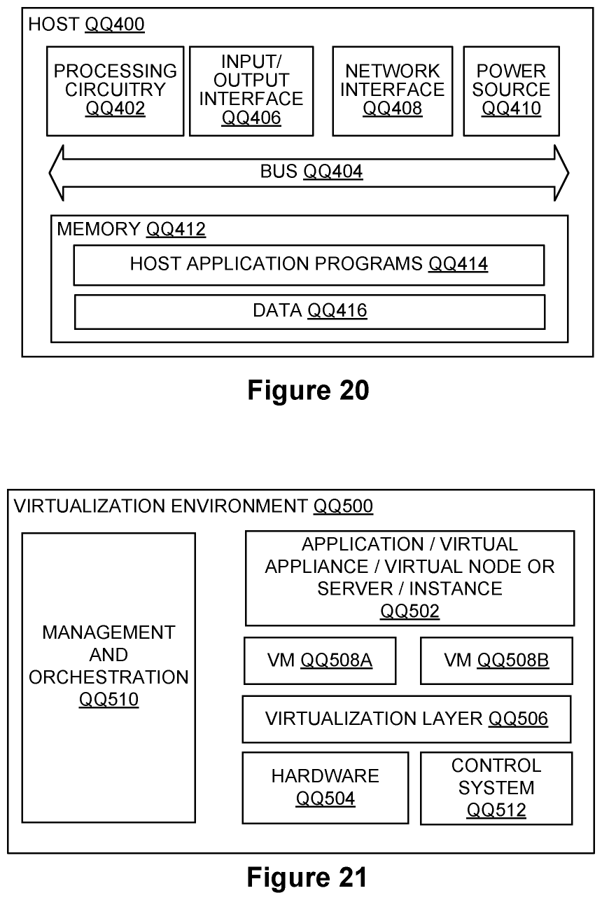

FIG. 20 is a block diagram of a host QQ400, which may be an embodiment of the host QQ116 of FIG. 17, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ610, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

FIG. 22 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 17 and/or UE QQ200 of FIG. 18), network node (such as network node QQ110a of FIG. 17 and/or network node QQ300 of FIG. 19), and host (such as host QQ116 of FIG. 17 and/or host QQ400 of FIG. 20) discussed in the preceding paragraphs will now be described with reference to FIG. 22.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 17) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

A listing of example embodiments of the present disclosure is provided below:
1. A method by a neuromorphic device in a wireless communication network, the method comprising:
   obtaining (700) a high dimensional, HD, vector containing symbols, wherein at least some of the symbols have a value operative to indicate a pattern of firing events for associated one or more neurons of a neural network, NN; and
   for each symbol in the HD vector having a nonzero value,
      selecting (702) a subframe of a radio frame and/or a carrier frequency among a set of carrier frequencies, based on a defined mapping between subframes of the radio frame and/or carrier frequencies of the set and the locations of symbols in the HD vector,
      determining (704) a time offset relative to the selected subframe and/or a frequency offset relative to the selected carrier frequency, based on the value of the symbol, and
      transmitting (706) an impulse at the determined time offset relative to the selected subframe and/or at the determined frequency offset relative to the selected carrier frequency.
2. The method of Embodiment 1, further comprising:
   transmitting no impulse for any symbol in the HD vector having a zero value.
3. The method of any of Embodiments 1 to 2, wherein:
   the determining (704) determines a value of the time offset and/or a value of the frequency offset based on processing the value of the symbol through a linear function that maps symbol values to time offset values and/or to frequency offset values.
4. The method of any of Embodiments 1 to 3, wherein:
   the selecting (702) selects the subframe of the radio frame based on the defined mapping between subframes of the radio frame and the locations of symbols in the HD vector;
   the determining (704) determines the time offset relative to the selected subframe based on the value of the symbol, and
   the transmitting (706) transmits the impulse at the determined time offset relative to the selected subframe.
5. The method of Embodiment 4:
   further comprising determining an assignment of the neuromorphic device to one of a plurality of slots in the subframe of the radio frame; and
   wherein the transmitting (706) transmits the impulse at the determined time offset in the one of the slots.
6. The method of Embodiment 4, further comprising:
   for each symbol in the HD vector having a nonzero value, randomly selecting one of a plurality of slots in the subframe of the radio frame, and
      wherein the transmitting (706) transmits the impulse at the determined time offset in the one of the slots.
7. The method of any of Embodiments 1 to 6, wherein:
   the selecting (702) selects the carrier frequency among the set of carrier frequencies based on the defined mapping between carrier frequencies of the set and the locations of symbols in the HD vector;
   the determining (704) determines the frequency offset relative to the selected carrier frequency based on the value of the symbol; and
   the transmitting (706) transmits the impulse at the determined frequency offset relative to the selected carrier frequency.
8. A computer program comprising program code to be executed by processing circuitry of a neuromorphic device in a wireless communication network, whereby execution of the program code causes the neuromorphic device to perform operations according to any of Embodiments 1 to 7.
9. A computer program product comprising a non-transitory storage medium including program code to be executed by processing circuitry of a neuromorphic device in a wireless communication network, whereby execution of the program code causes the neuromorphic device to perform operations according to any of Embodiments 1 to 7.
10. A method by a device in a wireless communication network, the method comprising:
   for an impulse that was received, identifying (900) a time offset in a subframe of a radio frame when the impulse was received and/or a frequency offset of the impulse relative to a carrier frequency;
   determining (902) a value of a symbol based on the identified time offset and/or frequency offset, wherein the value of the symbol operates to indicate a pattern of firing events for associated one or more neurons of a neural network, NN;
   storing (904) the value of the symbol at a location in a high dimensional, HD, vector determined based on a defined mapping between: locations of symbols in the HD vector; and subframes of the radio frame and/or carrier frequencies of a set.
11. The method of Embodiment 10, wherein:
the determining (902) determines a value of the symbol based on processing the determined time offset and/or the frequency offset, through a linear function that maps symbol values to time offset values and/or to frequency offset values.
12. The method of any of Embodiments 10 to 11, wherein:
   the identifying (900) identifies the time offset in the subframe of the radio frame when the impulse was received;
   the determining (902) determines the value of the symbol based on the identified time offset;
   the storing (904) stores the value of the symbol at the location in the HD vector determined based on the defined mapping between locations of symbols in the HD vector and the subframes of the radio frame.
13. The method of Embodiment 12, further comprising:
   repeating the identifying (900) for a plurality of impulses received in the subframe of the radio frame,
   wherein the determining (902) determines the value of the symbol based on combining the identified time offsets.
14. The method of Embodiment 13, wherein the combining comprises summing the identified time offsets.
15. The method of Embodiment 12:
   wherein the time offset is a phase;
   further comprising repeating the identifying (900) for a plurality of impulses received in the subframe of the radio frame,
   wherein the determining (902) determines the value of the symbol based on combining the phases of the plurality of impulses.
16. The method of any of Embodiments 10 to 15, wherein:
   the identifying (900) identifies the frequency offset of the impulse relative to the carrier frequency;
   the determining (902) determines the value of the symbol based on the identified frequency offset;
   the storing (904) stores the value of the symbol at the location in the HD vector determined based on the defined mapping between locations of symbols in the HD vector and the carrier frequencies of the set.
17. The method of Embodiment 16, further comprising:
   repeating the identifying (900) for a plurality of impulses received in the subframe of the radio frame,
   wherein the determining (902) determines the value of the symbol based on combining the identified frequency offsets.
18. The method of Embodiment 17, wherein the combining comprises summing the identified frequency offsets.
19. The method of any of Embodiments 10 to 18:
   wherein the device comprises a base station which receives the impulses in an uplink direction from a plurality of devices;
   further comprising transmitting the HD vector in a downlink direction.
20. The method of Embodiment 19, further comprising:
   receiving a locally bundled HD vector from another device;
   combining the HD vector generated by the device with the locally bundled HD vector from the other device to generate a combined HD vector; and
   transmitting the combined HD vector in the downlink direction.
21. A computer program comprising program code to be executed by processing circuitry of a device in a wireless communication network, whereby execution of the program code causes the device to perform operations according to any of Embodiments 10 to 20.
22. A computer program product comprising a non-transitory storage medium including program code to be executed by processing circuitry of a device in a wireless communication network, whereby execution of the program code causes the device to perform operations according to any of Embodiments 10 to 20.
23. A neuromorphic device (620) in a wireless communication network, the neuromorphic device (620) adapted to:
   obtain a high dimensional, HD, vector containing symbols, at least some of the symbols have a value operative to indicate a pattern of firing events for associated one or more neurons of a neural network, NN; and
   for each symbol in the HD vector having a nonzero value,
      select a subframe of a radio frame and/or a carrier frequency among a set of carrier frequencies, based on a defined mapping between subframes of the radio frame and/or carrier frequencies of the set and the locations of symbols in the HD vector,
      determine a time offset relative to the selected subframe and/or a frequency offset relative to the selected carrier frequency, based on the value of the symbol, and
      transmit an impulse at the determined time offset relative to the selected subframe and/or at the determined frequency offset relative to the selected carrier frequency.
24. A device (820) in a wireless communication network, the device (820) adapted to:
   for an impulse that was received, identify a time offset in a subframe of a radio frame when the impulse was received and/or a frequency offset of the impulse relative to a carrier frequency;
   determine a value of a symbol based on the identified time offset and/or frequency offset, wherein the value of the symbol operates to indicate a pattern of firing events for associated one or more neurons of a neural network, NN;
   store the value of the symbol at a location in a high dimensional, HD, vector determined based on a defined mapping between: locations of symbols in the HD vector; and subframes of the radio frame and/or carrier frequencies of a set.

1. A method by a neuromorphic device in a wireless communication network which communicates using radio frames and carrier frequencies, the method comprising:
obtaining a high dimensional (HD) vector containing symbols, wherein at least some of the symbols have a value operative to indicate a pattern of firing events for associated one or more neurons of a neural network (NN); and
for each symbol in the HD vector having a nonzero value,
selecting a subframe of a radio frame and/or a carrier frequency among a set of carrier frequencies, based on a defined mapping between subframes of the radio frame and/or carrier frequencies of the set and the locations of symbols in the HD vector,
determining a time offset relative to the selected subframe and/or a frequency offset relative to the selected carrier frequency, based on the value of the symbol, and
transmitting an impulse at the determined time offset relative to the selected subframe and/or at the determined frequency offset relative to the selected carrier frequency.

2. The method of claim 1, further comprising:
transmitting no impulse for any symbol in the HD vector having a zero value.

3. The method of claim 1, wherein:
the determining of the time offset includes determining a value of the time offset and/or a value of the frequency offset based on processing the value of the symbol through a linear function that maps symbol values to time offset values and/or to frequency offset values.

4. The method of claim 1, wherein:
the selecting includes selecting the subframe of the radio frame based on the defined mapping between subframes of the radio frame and the locations of symbols in the HD vector;
the determining includes determining the time offset relative to the selected subframe based on the value of the symbol, and
the transmitting includes transmitting the impulse at the determined time offset relative to the selected subframe.

5. The method of claim 4, further comprising:
determining an assignment of the neuromorphic device to one of a plurality of slots in the subframe of the radio frame,
wherein the transmitting includes transmitting the impulse at the determined time offset in the one of the slots.

6. The method of claim 4, further comprising:
for each symbol in the HD vector having a nonzero value,
randomly selecting one of a plurality of slots in the subframe of the radio frame,
wherein the transmitting transmits the impulse at the determined time offset in the one of the slots.

7. The method of claim 1, wherein:
the selecting selects the carrier frequency among the set of carrier frequencies based on the defined mapping between carrier frequencies of the set and the locations of symbols in the HD vector;
the determining determines the frequency offset relative to the selected carrier frequency based on the value of the symbol; and
the transmitting transmits the impulse at the determined frequency offset relative to the selected carrier frequency.

8-9. (canceled)

10. A method by a device in a wireless communication network which communicates using radio frames and carrier frequencies, the method comprising:
for an impulse that was received, identifying a time offset in a subframe of a radio frame when the impulse was received and/or a frequency offset of the impulse relative to a carrier frequency;
determining a value of a symbol based on the identified time offset and/or frequency offset, wherein the value of the symbol operates to indicate a pattern of firing events for associated one or more neurons of a neural network (NN);
storing the value of the symbol at a location in a high dimensional (HD) vector determined based on a defined mapping between: locations of symbols in the HD vector; and subframes of the radio frame and/or carrier frequencies of a set.

11. The method of claim 10, wherein:
the determining includes determining a value of the symbol based on processing the determined time offset and/or the frequency offset, through a linear function that maps symbol values to time offset values and/or to frequency offset values.

12. The method of claim 10, wherein:
the identifying identifies the time offset in the subframe of the radio frame when the impulse was received;
the determining determines the value of the symbol based on the identified time offset; and
the storing stores the value of the symbol at the location in the HD vector determined based on the defined mapping between locations of symbols in the HD vector and the subframes of the radio frame.

13. The method of claim 12, further comprising:
repeating the identifying for a plurality of impulses received in the subframe of the radio frame,
wherein the determining determines the value of the symbol based on combining the identified time offsets.

14. The method of claim 13, wherein the combining comprises summing the identified time offsets.

15. The method of claim 12:
wherein the time offset is a phase;
further comprising repeating the identifying for a plurality of impulses received in the subframe of the radio frame,
wherein the determining determines the value of the symbol based on combining the phases of the plurality of impulses.

16. The method of claim 10, wherein:
the identifying identifies the frequency offset of the impulse relative to the carrier frequency;
the determining determines the value of the symbol based on the identified frequency offset;
the storing stores the value of the symbol at the location in the HD vector determined based on the defined mapping between locations of symbols in the HD vector and the carrier frequencies of the set.

17. The method of claim 16, further comprising:
repeating the identifying for a plurality of impulses received in the subframe of the radio frame,
wherein the determining determines the value of the symbol based on combining the identified frequency offsets.

18. The method of claim 17, wherein the combining comprises summing the identified frequency offsets.

419. The method of claim 10:
wherein the device comprises a base station which receives the impulses in an uplink direction from a plurality of devices;
further comprising transmitting the HD vector in a downlink direction.

20. The method of claim 19, further comprising:
receiving a locally bundled HD vector from another device;
combining the HD vector generated by the device with the locally bundled HD vector from the other device to generate a combined HD vector; and
transmitting the combined HD vector in the downlink direction.

21-22. (canceled)

23. A neuromorphic device in a wireless communication network which communicates using radio frames and carrier frequencies, the neuromorphic device adapted to:
obtain a high dimensional (HD) vector containing symbols, at least some of the symbols have a value operative to indicate a pattern of firing events for associated one or more neurons of a neural network (NN); and
for each symbol in the HD vector having a nonzero value,
select a subframe of a radio frame and/or a carrier frequency among a set of carrier frequencies, based on a defined mapping between subframes of the radio frame and/or carrier frequencies of the set and the locations of symbols in the HD vector,
determine a time offset relative to the selected subframe and/or a frequency offset relative to the selected carrier frequency, based on the value of the symbol, and
transmit an impulse at the determined time offset relative to the selected subframe and/or at the determined frequency offset relative to the selected carrier frequency.

24-26. (canceled)
